(19) United States
(12) Patent Application Publication
(10) Pub. No.: US 2026/0179911 A1
(43) Pub. Date: Jun. 25, 2026

(54) Anode for Secondary Battery, Method of Fabricating the Same and Secondary Battery Including the Same

(71) Applicant: SK On Co., Ltd., Seoul (KR)

(72) Inventors: Mi Ju BAE, Daejeon (KR); Yeong Min JO, Daejeon (KR); In Ha KIM, Daejeon (KR); In Yong SHIN, Daejeon (KR); Se Mi LEE, Daejeon (KR); Chi Won JEON, Daejeon (KR)

(21) Appl. No.: 19/424,357

(22) Filed: Dec. 18, 2025

(30) Foreign Application Priority Data
Dec. 23, 2024 (KR) 10-2024-0194234

(51) Int. Cl. H01M 4/133; H01M 4/02; H01M 4/04; H01M 4/1393; H01M 4/583; H01M 4/62; H01M 10/0525

(52) U.S. Cl. CPC H01M 4/133; H01M 4/0435; H01M 4/1393; H01M 4/583; H01M 4/623; H01M 10/0525; H01M 2004/021; H01M 2004/027

(57) ABSTRACT

An anode for a secondary battery, a method of fabricating the anode and a secondary battery including the anode are provided. The anode for a secondary battery includes an anode current collector, and an anode active material layer formed on a surface of the anode current collector. The anode active material layer includes a graphite-based active material as an anode active material and polytetrafluoroethylene (PTFE) as a binder. A crystallinity defined by I_{PTFE}(100)/I_{GR(002)} and measured on a surface of the anode active material layer is 0.005 or less.

### CROSS-REFERENCE TO RELATED APPLICATION

This application claims priority to Korean Patent Application No. 10-2024-0194234 filed on Dec. 23, 2024, the entire disclosure of which is incorporated by reference herein.

### BACKGROUND

### 1. Field

The disclosure of this patent application relates to an anode for a lithium secondary battery, a method of fabricating the same, and a lithium secondary battery including the same. More particularly, the disclosure of this patent application relates to an anode for a lithium secondary battery including an active material and a binder, a method of fabricating the same, and a lithium secondary battery including the same.

### 2. Descriptions of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of an eco-friendly vehicle such as a hybrid automobile, an electric vehicle, etc.

Examples of the secondary battery include a lithium secondary battery, a nickel-cadmium battery, a nickel-hydrogen battery, etc. The lithium secondary battery among the secondary batteries is being actively developed due to high operational voltage and energy density per unit weight, a high charging rate, a compact dimension, etc.

The secondary battery may include an electrode assembly including repeatedly stacked cathodes and anodes, and may further include an electrolyte that may impregnate the electrode assembly. The lithium secondary battery may further include an outer packaging material, e.g., a cylindrical shape or a pouch shape, that may accommodate the electrode assembly and the electrolyte.

For example, an electrode (the cathode and the anode) of the secondary battery may be formed using a slurry formed by mixing an active material and a binder in a solvent. The slurry may be coated on a current collector, and then dried and pressed to form an electrode active material layer.

However, the drying process of the slurry may cause defects such as pinholes in the electrode active material layer, and non-uniform distribution of the active material may also be caused to deteriorate battery performance. Thus, a method for fabricating a dry electrode without using a solvent is being developed.

### SUMMARY

According to an aspect of the present disclosure, there is provided an anode for a lithium secondary battery having improved mechanical and electrical properties.

According to an aspect of the present disclosure, there is provided a method of fabricating an anode for a lithium secondary battery having improved mechanical and electrical properties.

According to an aspect of the present disclosure, there is provided a lithium secondary battery having improved mechanical and electrical properties.

An anode for a secondary battery includes an anode current collector, and an anode active material layer formed on a surface of the anode current collector. The anode active material layer includes a graphite-based active material as an anode active material and polytetrafluoroethylene (PTFE) as a binder. A crystallinity defined by Equation 1 and measured on a surface of the anode active material layer is 0.005 or less.

$$crystallinity = {I}_{PTFE} ( 1 \; 00 ) / {I}_{GR} ( 002 ) \qquad [ Equation 1 ]$$

In Equation 1, I_{PTFE}(100) is an intensity of a peak corresponding to a (100) plane of PTFE in an X-ray diffraction (XRD) graph obtained by an XRD analysis, and I_{GR}(002) is an intensity of a peak corresponding to a (002) plane of graphite in the XRD graph.

In some embodiments, the crystallinity of the anode active material layer of Equation 1 may be in a range from 0.002 to 0.005.

In some embodiments, the anode active material may include artificial graphite.

In some embodiments, the anode active material may further include natural graphite, and a content of artificial graphite may be greater than or equal to a content of natural graphite based on a total weight of the anode active material.

In some embodiments, the content of artificial graphite may be in a range from 10 wt % to 90 wt % based on the total weight of the anode active material.

In some embodiments, the anode active material layer may further include a conductive material. A content of the anode active material may be in a range from 85 wt % to 99 wt %, a content of the binder may be in a range from 0.1 wt % to 10 wt %, and a content of the conductive material may be in a range from 0.1 wt % to 10 wt %, based on a total weight of the anode active material layer.

In some embodiments, the crystallinity of Equation 1 may be an average of measured values at a plurality of points on the surface of the anode active material layer.

In some embodiments, a relative standard deviation (RSD) of the measured values may be 10% or less.

In some embodiments, a relative standard deviation (RSD) of the measured values may be 5% or less.

A secondary battery includes the above-described anode for a secondary battery, and a cathode opposing the anode.

In some embodiments, the cathode may include a cathode active material layer that may include a cathode active material and PTFE as a binder.

In a method for fabricating an anode for a secondary battery, a graphite-based active material as an anode active material, polytetrafluoroethylene (PTFE) as a binder, and a conductive material are mixed to prepare a dry powder. Calendering of the dry powder may be performed to prepare an anode sheet. A crystallinity of the dry powder defined by Equation 1 is 0.009 or less.

$$crystallinity = {I}_{PTFE} ( 1 \; 00 ) / {I}_{GR} ( 002 ) \qquad [ Equation 1 ]$$

In Equation 1, I_{PTFE}(100) is an intensity of a peak corresponding to a (100) plane of PTFE in an X-ray diffraction (XRD) graph obtained by an XRD analysis, and I_{GR}(002) is an intensity of a peak corresponding to a (002) plane of graphite in the XRD graph.

In some embodiments, the crystallinity of the dry powder defined by Equation 1 may be 0.005 or more, and less than 0.009.

In some embodiments, in the preparing of the dry powder, a preliminary powder may be prepared by stirring the anode active material and the conductive material by a first mixing process. The preliminary powder and the binder may be stirred by a second mixing.

In some embodiments, a stirring rate of the first mixing and the second mixing may each be 6,000 rpm or more, and a stirring time of the second mixing may be greater than or equal to a stirring time of the first mixing.

According to embodiments of the present disclosure, an electrode may be fabricated by a dry process using a binder capable of being fiberized. Accordingly, a solvent-induced fluctuation in electrode performance and properties may be prevented, thereby stably providing desired capacity and power properties.

According to embodiments of the present disclosure, a degree of fibrillation in an electrode active material layer may be predicted by analyzing a crystallinity by an XRD. A crystallinity may be controlled, so that an electrode resistance may be lowered and desired power properties may be uniformly achieved.

The electrode for a secondary battery and a secondary battery according to the present disclosure may be widely applied in green technology fields such as an electric vehicle, a battery charging station, a solar power generation, a wind power generation, etc., using a battery, etc. An anode for a secondary battery and a lithium secondary battery according to the present disclosure may be used for eco-friendly electric vehicles and hybrid vehicles to prevent a climate change by suppressing air pollution and greenhouse gas emissions. etc.

### BRIEF DESCRIPTION OF THE DRAWINGS

FIG. 1 is a schematic cross-sectional view illustrating an anode for a secondary battery according to example embodiments.

FIG. 2 and FIG. 3 are a schematic plan view and a cross-sectional view, respectively, of a secondary battery according to example embodiments.

FIGS. 4 to 6 are scanning electron microscope (SEM) images of an anode powder of Example 1, Example 2 and Comparative Example 1, respectively.

### DETAILED DESCRIPTION OF THE EMBODIMENTS

According to embodiments of the present disclosure, an electrode for a secondary battery including a binder and an active material is provided. Further, according to embodiments of the present disclosure, a secondary battery including the electrode is provided.

Hereinafter, the present disclosure will be described in detail with reference to the attached drawings and example embodiments. However, those are merely provided as examples and the present disclosure is not limited to the specific embodiments disclosed herein.

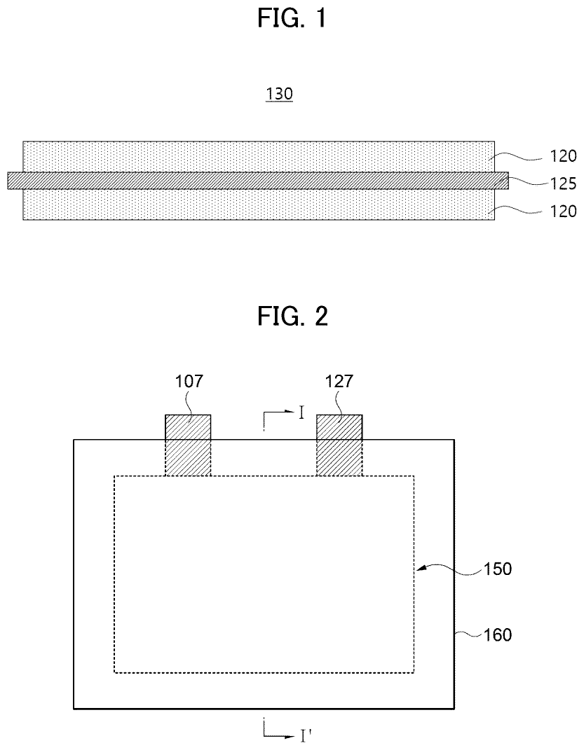

FIG. 1 is a schematic cross-sectional view illustrating an anode for a secondary battery according to example embodiments.

Referring to FIG. 1, an anode 130 for for a lithium secondary battery (hereinafter, that may be abbreviated as an anode) may include an anode current collector 125 and an anode active material layer 120.

For example, the anode current collector 125 may include copper, stainless steel, nickel, titanium, or an alloy thereof. In an embodiment, the anode current collector 125 may include copper or stainless steel surface-treated with carbon, nickel, titanium or silver. A thickness of the anode current collector 125 may be, e.g., in a range from 5 μm to 50 μm.

The anode active material layer 120 may be disposed on at least one surface of the surface of the anode current collector 125. The anode active material layer 120 may be formed on each of both surfaces (an upper surface and a lower surface) of the anode current collector 125.

The anode active material layer 120 may include an anode active material and a binder. The anode active material layer 120 may further include a conductive material. The anode active material layer 120 may be formed by a dry coating method as described later, and the anode 130 may be provided as a dry electrode.

In example embodiments, the anode active material may include a graphite-based material. In some embodiments, the anode active material may include artificial graphite.

In some embodiments, the anode active material may include a mixture of artificial graphite and natural graphite. In an embodiment, a content of artificial graphite in the mixture may be in a range from 10 wt % to 90 wt %, from 20 wt % to 80 wt %, or from 30 wt % to 70 wt %.

Artificial graphite may have relatively high chemical stability and high dispersion properties compared to those of natural graphite. Thus, decrease in reliability and increase in deviation of measured values of a binder crystallinity caused by aggregation of an active material may be prevented.

Natural graphite may provide relatively increased capacity properties compared to those of artificial graphite. Accordingly, natural graphite may be mixed in the above-described content range, so that capacity properties from the anode 130 may be improved while maintaining reliability of the measured values of the binder crystallinity through artificial graphite.

In some embodiments, the anode active material may further include a silicon-based active material (e.g., a silicon-containing active material).

The silicon-based active material may include Si, SiOx (0<x<2), a silicon-carbon composite (Si/C), a silicon oxide (silicon)-carbon composite (SiO/C), a silicon metal (Si-Metal), or the like. In some embodiments, the silicon-based active material may include a lithium-silicate compound, a lithium-silicate compound containing a dopant such as magnesium, aluminum, or the like.

In some embodiments, the silicon-based active material may include the silicon-carbon composite. The silicon-carbon composite may include a carbon core and a silicon coating formed on the carbon core.

For example, the carbon core may have a porous structure, and the silicon coating may be formed on the porous carbon structure through a deposition process such as chemical vapor deposition (CVD).

In example embodiments, a content of the graphite-based active material may be in a range from 60 wt % to 95 wt %, and a content of the silicon-based active material (e.g., the silicon-carbon composite) may be in a range from 5 wt % to 40 wt, based on a total weight of the anode active material. In some embodiments, the content of the graphite-based active material may be in a range from 75 wt % to 95 wt %, from 77 wt % to 92 wt %, or from 80 wt % to 90 wt %, and the content of the silicon-based active material may be in a range from 5 wt % to 25 wt %, from 8 wt % to 23 wt %, or from 10 wt % to 20 wt %.

The binder may include a polymer material capable of providing an adhesive force to the anode active material layer 120 through a dry process as will be described later. The binder may include a polymer that may be fiberized by a mixing through applying a shear force. According to embodiments of the present disclosure, the binder may include polytetrafluoroethylene (PTFE).

In some embodiments, the binder may further include an auxiliary binder together with PTFE. The auxiliary binder may include polyacrylic acid (PAA), carboxymethylcellulose (CMC), polyacrylonitrile, polymethylmethacrylate, polyvinylidene fluoride (PVDF), poly(vinylidene fluoride-co-hexafluoropropylene). These may be used alone or in a combination of two or more therefrom.

The conductive material may be added to enhance mobility of lithium ions or electrons. For example, non-limiting examples of the conductive material may include a carbon-based conductive material such as graphite, carbon black, acetylene black, ketjen black, graphene, carbon nanotube, a vapor-grown carbon fiber (VGCF), a carbon fiber, etc., and/or a metal-based conductive material including tin, tin oxide, titanium oxide, a perovskite material such as LaSrCoO₃, LaSrMnO₃, etc.

In an embodiment, the carbon-based conductive material excluding graphite may be used as the conductive material.

A content of the anode active material may be in a range from 85 wt % to 99 wt %, a content of the binder may be in a range from 0.1 wt % to 10 wt %, and a content of the conductive material may be in a range from 0.1 wt % to 10 wt % based on a total weight of the anode active material layer 120.

In some embodiments, the content of the anode active material may be in a range from 90 wt % to 98 wt %, the content of the binder may be in a range from 0.5 wt % to 5 wt %, and the content of the conductive material may be in a range from 0.5 wt % to 5 wt % based on the total weight of the anode active material layer 120.

According to the present disclosure, the anode 130 may be prepared by a dry method.

A dry powder may be prepared by mixing the above-described anode active material, binder and conductive material. For example, the dry powder may be prepared by mixing the anode active material, the binder and the conductive material using a stirrer such as a ball-mill without substantially using a solvent.

In some embodiments, a stirring rate during the mixing may be 6,000 rpm or more. In an embodiment, the stirring rate during the mixing may be 7,000 rpm or more, or 8,000 rpm or more. For example, the stirring rate may be in a range from 6,000 rpm to 10,000 rpm, from 7,000 rpm to 10,000 rpm, or from 8,000 rpm to 10,000 rpm.

In the stirring rate range, a uniform fibrillation degree in a substantially entire region of the anode active material layer 120 may be maintained while achieving a sufficient fibrillation degree of PTFE.

In some embodiments, during the mixing, the stirring time may be maintained in a range of 5 minutes to 15 minutes, from 5 minutes to 10 minutes, or from 6 minutes to 10 minutes. In the stirring time range, a uniform crystallinity value according to Equation 1 as will be described later may be effectively maintained in substantially the entire region of the anode active material layer 120 while achieving the sufficient fibrillation of PTFE.

In some embodiments, the mixing may include a first mixing and a second mixing. Through the first mixing, a preliminary powder in which the anode active material and the conductive material are pre-mixed may be prepared. Thereafter, the binder may be added to the preliminary powder and the second mixing may be performed.

The anode active material may be pre-mixed through the first mixing, so that reduction of reliability of the crystallinity value of Equation 1 by aggregation of the active material may be prevented, and dispersive properties of the binder may be improved by using the preliminary powder.

When the mixing is divided into the first and second mixing, the stirring time of the second mixing may be equal to or greater than the stirring time of the first mixing. Accordingly, a sufficient fibrillation period of the binder may be achieved.

The stirring rate of each of the first mixing and the second mixing and a total mixing tine may be maintained in the above-described range.

An anode sheet may be manufactured by performing a calendering process using the dry powder prepared as described above. For example, the dry powder may be pressed between a pair of rolls without substantially using a solvent. Accordingly, an anode sheet in the form of a pre-standing film may be manufactured.

For example, a temperature of the rolls may be maintained at a temperature in a range from 50° C. to 150° C., from 60° C. to 150° C., from 70° C. to 150° C., or from 80° C. to 150° C.

The anode sheet may be laminated on the anode current collector 125 through pressing. Accordingly, the anode 130 including the anode active material layer 120 coated on the anode current collector 125 may be obtained.

For example, the anode sheet may be placed on a surface (e.g., both surfaces) of the anode current collector while supplying the anode current collector 125, and the anode sheet may pass through between lamination rolls. Accordingly, the anode current collector 125 and the anode sheet may be adhered to obtain the anode 130 in the form of a dry electrode.

According to embodiments of the present disclosure, a crystallinity measured on the surface of the anode active material layer 120 and defined by Equation 1 may be 0.005 or less. According to embodiments of the present disclosure, the crystallinity of the anode active material layer 120 may be measured on a top surface of the anode active material layer 120 opposing a contact surface with the anode current collector 125 of the anode active material layer 120.

$$crystallinity = {I}_{PTFE} ( 1 \; 00 ) / {I}_{GR} ( 002 ) \qquad [ Equation 1 ]$$

In Equation 1, I_{PTFE}(100) is an intensity of a peak corresponding to a (100) plane of PTFE in an X-ray diffraction (XRD) graph obtained by the XRD analysis. I_{GR}(002) is an intensity of a peak corresponding to a (002) plane of graphite in the XRD graph. The intensity of the peak may refer to a maximum height of the corresponding peak.

According to embodiments of the present disclosure, the I_{PTFE}(100) may be used as an index reflecting the crystallinity of PTFE in the anode active material layer 120.

I_{GR}(002) may be used as an index indicating a crystallinity of the anode active material in the anode active material layer 120.

For example, I_{GR}(002) may be an intensity of a peak observed in a range of a diffraction angle (2θ) of 25° to 28° in the XRD graph. I_{PTFE}(100) may be an intensity of the peak observed in a range of the diffraction angle (2θ) of 54° to 56°.

For example, the XRD analysis may be measured according to conditions of Table 1 as will be described later.

I_{PTFE}(100) may reflect a fibrillation degree of PTFE used as a dry binder. I_{GR}(002) may reflect an overall crystallinity of the anode active material layer 120 including the graphite-based active material.

As described above, determining an overall fibrillation degree of the binder in the dry electrode using an absolute crystallinity or fibrillation degree of the binder contained in a relatively small amount in the anode active material layer 120 may provide a low reliability, and non-uniform measured values may be calculated according to measurement locations.

However, according to embodiments of the present disclosure, the overall fibrillation degree of the binder of the anode active material layer 120 may be managed and confirmed using a relative crystallinity value compared to I_{GR}(002) indicating the crystallinity of the graphite-based active material.

When the crystallinity of Equation 1 of the anode active material layer 120 exceeds 0.005, a fibrillation of PTFE may not be sufficient, and an amount of a crystalline binder may be excessively increased. Accordingly, decrease in dispersibility of the binder and an increase in resistance may be caused in the anode 130. Further, mechanical damages such as tearing of the anode 130 may be caused in the calendering or lamination process due to decrease in flexibility of the anode active material layer 120.

In some embodiments, the crystallinity of Equation 1 of the anode active material layer 120 may be in a range from 0.001 to 0.005, from 0.002 to 0.005, from 0.002 to 0.004, or from 0.002 to 0.0036. In the above range, a resistance of the anode 130 may be effectively reduced, and process reliability of the anode 130 may be maintained or improved.

In example embodiments, after measuring the crystallinity of Equation 1 at each of a plurality of points on a surface of the anode active material layer 120, an average of the measured values may be used as the crystallinity of Equation 1 of the anode active material layer 120. For example, the average of the measured values at five different points on the surface of the anode active material layer 120 may be used as the crystallinity of Equation 1 of the anode active material layer 120.

In some embodiments, a relative standard deviation (RSD) of the crystallinity defined by Equation 1 of the anode active material layer 120 may be 10% or less. In the above RSD range, uniform binder dispersibility and resistance properties may be effectively managed and maintained substantially throughout an entire area of the anode active material layer 120.

In an embodiment, the relative standard deviation (RSD) of the crystallinity defined by Equation 1 of the anode active material layer 120 may be 7% or less, 6% or less, or 5% or less. For example, the relative standard deviation (RSD) of the crystallinity defined by Equation 1 of the anode active material layer 120 may be in a range from 2% to 7%, from 3% to 6%, or from 3% to 5%.

As described above, the anode 130 may be fabricated by a dry process including a calendering process and/or a lamination process using a dry powder. In example embodiments, the crystallinity of Equation 1 of the dry powder may be 0.009 or less. The dry powder in the crystallinity range may be used, so that the crystallinity range defined by Equation 1 of the anode active material layer 120 may be more efficiently implemented.

In some embodiments, the crystallinity of Equation 1 of the dry powder may be 0.005 or more, and less than 0.009. In an embodiment, the crystallinity of Equation 1 of the dry powder may be 0.006 or more, and less than 0.009.

For example, the crystallinity of Equation 1 of the dry powder may be measured multiple times, and an average of the measured values may be used as the crystallinity of the dry powder. In some embodiments, a relative standard deviation (RSD) of the dry powder may be 10% or less. In an embodiment, the relative standard deviation (RSD) of the dry powder may be 5% or less. For example, the relative standard deviation (RSD) of the crystallinity defined by Equation 1 of the dry powder may be in a range from 1% to 5%, from 1% to 4%, or from 1.5% to 4%.

Uniformity of the crystallinity in the anode active material layer 120 may be more easily achieved using the dry powder having the above-described relative standard deviation, and uniformity of the resistance of the anode 130 may be improved.

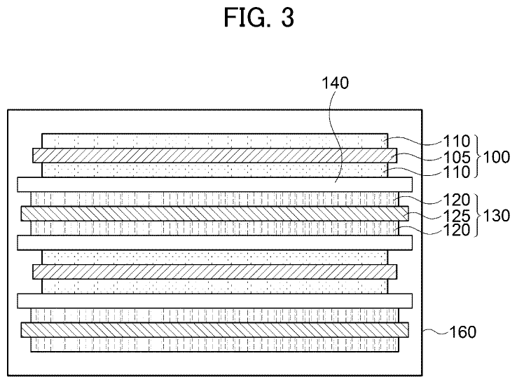

FIGS. 2 and 3 are a schematic plan view and a cross-sectional view illustrating a secondary battery according to embodiments, respectively. For example, FIG. 3 is a cross-sectional view taken along a line I-I′ of FIG. 2 in a thickness direction. FIG. 2 and FIG. 3 provide a schematic construction of the secondary battery structure for convenience of descriptions, and a shape and a structure of the secondary battery of the present disclosure are not limited thereto.

Referring to FIGS. 2 and 3, the lithium secondary battery includes the anode 130 including the anode active material layer 120 and the anode current collector 125 as described above, and a cathode 100. The secondary battery may further include a separator 140 interposed between the cathode 100 and the anode 130.

In some embodiments, the anode 100 may also be a dry electrode fabricated by the above-described dry method. For example, a dry powder may be prepared by mixing a cathode active material and the above-described binder without substantially using a solvent. The above-described conductive material may also be included in the dry powder preparation. The cathode 100 including a cathode active material layer 110 and a cathode current collector 105 may be fabricate by a calendering process and/or a lamination process using the dry powder.

The cathode current collector 105 may include stainless steel, nickel, aluminum, titanium, or an alloy thereof. The cathode current collector 105 may include aluminum or stainless steel surface-treated with carbon, nickel, titanium, silver, or the like. For example, a thickness of the cathode current collector 105 may be in a range from 5 μm to 50 μm.

The cathode active material may include a compound capable of reversibly intercalating and de-intercalating lithium ions. In example embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may have a layered structure or a crystal structure represented by Chemical Formula 1.

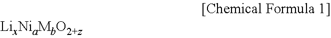

In Chemical Formula 1, 0.9≤x≤1.2, 0.5≤a≤0.99, 0.01≤b≤0.5, and −0.5≤z≤0.1. As described above, M may include Co, Mn and/or Al.

The chemical structure represented by Chemical Formula 1 represents a bonding relationship included in the layered structure or crystal structure of the cathode active material, and is not intended to exclude another additional element. For example, M includes Co and/or Mn, and Co and/or Mn may serve as a main active element of the cathode active material together with Ni. Chemical Formula 1 is provided to express the bonding relationship of the main active element above, and is to be understood as encompassing introduction and substitution of the additional element.

In an embodiment, an auxiliary element may be further included in addition to the main active element to promote chemical stability of the cathode active material or the layered structure/crystal structure. The auxiliary element may be incorporated together in the layered structure/crystal structure to form a bond, and this case is to be understood as being included within the range of the chemical structure represented by Chemical Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P or Zr. The auxiliary element may function as an auxiliary active element such as Al contributing to capacity and power activity of the cathode active material together with Co or Mn.

For example, the cathode active material or the lithium-nickel metal oxide may include a layered structure or a crystal structure represented by Chemical Formula 1-1.

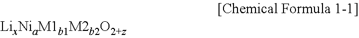

In Chemical Formula 1, M1 may include Co, Mn and/or Al. M2 may include the above-described auxiliary element. In Chemical Formula 1-1, 0.9≤x≤1.2, 0.5≤a≤0.99, 0.01≤b1+b2≤0.5, and −0.5≤z≤0.1.

The cathode active material may further include a coating element or a doping element. For example, elements substantially the same as or similar to the above-described auxiliary elements may be used as the coating element or the doping element. For example, the above-described elements may be used alone or in a combination thereof as the coating element or the doping element.

The coating element or the doping element may be present on a surface of the lithium-nickel metal oxide particle, or may be included in a bonding structure represented by Chemical Formula 1 or 1-1 by penetrating through the surface of the lithium-nickel metal composite oxide particle.

The cathode active material may include a nickel-cobalt-manganese (NCM)-based lithium oxide. In this case, an NCM-based lithium oxide having an increased nickel content may be used.

Ni may be provided as a transition metal associated with a power and a capacity of the lithium secondary battery. Thus, a high-Ni composition as described above may be employed as the cathode active material, so that a high-capacity cathode a high-capacity lithium secondary battery may be provided.

However, as the Ni content increases, long-term storage stability and life-span stability of the cathode or the secondary battery may be relatively decreased, and side reactions with an electrolyte may be also increased. However, according to example embodiments, life-span stability and capacity retention properties may be improved through Mn while maintaining electrical conductivity by including Co.

The content of Ni in the NCM-based lithium oxide (e.g., a mole fraction of nickel based on a total number of moles of nickel, cobalt and manganese) may be 0.5 or more, 0.6 or more, 0.7 or more, or 0.8 or more. In some embodiments, the content of Ni may be in a range from 0.8 to 0.95, from 0.82 to 0.95, from 0.83 to 0.95, from 0.84 to 0.95, from 0.85 to 0.95, or from 0.88 to 0.95.

In some embodiments, the cathode active material may include a lithium cobalt oxide-based active material, a lithium manganese oxide-based active material, a lithium nickel oxide-based active material, or a lithium iron phosphate-based (LFP) active material (e.g., LiFePO₄).

In some embodiments, the cathode active material may include, e.g., an Mn-rich active material, an LLO (Li-rich layered oxide)/OLO (over-lithiated oxide) active material, a Co-free active material having a chemical structure or a crystal structure represented by Chemical Formula 2.

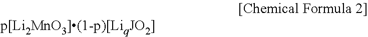

In Chemical Formula 2, 0<p<1 and 0.9≤q≤1.2, and J may include at least one element among Mn, Ni, Co, Fe, Cr, V, Cu, Zn, Ti, Al, Mg and B.

A content of the cathode active material may be in a range from 85 wt % to 99 wt %, a content of the binder may be in a range from 0.1 wt % to 10 wt %, and a content of the conductive material may be in a range from 0.1 wt % to 10 wt %, based on a total weight of the cathode active material layer 110.

In some embodiments, the content of the cathode active material may be in a range from 90 wt % to 98 wt %, the content of the binder may be in a range from 0.5 wt % to 5 wt %, and the content of the conductive material may be in a range from 0.5 wt % to 5 wt %, based on the total weight of the cathode active material layer 110.

The separator 140 may include a porous polymer film or a porous nonwoven fabric. The porous polymer film may include a polyolefin-based polymer such as an ethylene polymer, a propylene polymer, an ethylene/butene copolymer, ethylene/hexene copolymer, an ethylene/methacrylate copolymer, or the like. The porous nonwoven fabric may include a glass fiber having a high melting point, a polyethylene terephthalate fiber, or the like.

The separator 140 may include a ceramic-based material. For example, inorganic particles may be coated on a polymer film or dispersed in the polymer film to improve heat resistance.

According to embodiments, an electrode cell may be defined by the cathode 100, the anode 130 and a separator 140, and a plurality of the electrode cells may be stacked to form, e.g., an electrode assembly 150. The electrode assembly 150 may be a winding type, a stacking type, a zigzag-folding type, or a stack-folding type.

The electrode assembly 150 may be accommodated together with an electrolyte solution in a case 160 to define the lithium secondary battery. In example embodiments, a non-aqueous electrolyte solution may be used as the electrolyte solution.

The non-aqueous electrolyte solution may include a lithium salt as the electrolyte and an organic solvent. The lithium salt may be expressed as Li⁺X⁻, and an anion (X⁻) of the lithium salt may include, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, or the like.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dimethyl sulfoxide, acetonitrile, dimethoxyethane, diethoxyethane, vinylene carbonate, sulfolane, gamma-butyrolactone, propylene sulfite, tetrahydrofuran, or the like. These may be used alone or in a combination of two or more therefrom.

In some embodiments, a solid electrolyte may be used instead of the above-described non-aqueous electrolyte solution. In this case, the lithium secondary battery may be fabricated in the form of an all-solid state battery. Additionally, a solid electrolyte layer may be disposed instead of the above-described separator between the cathode and the anode.

The solid electrolyte may include a sulfide-based electrolyte. Non-limiting examples of the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m, n is a positive number, Z is Ge, Zn or Ga), Li₂S—GeS₂, Li₂S—SiS₂—Li₃PO₄, Li₂S—SiS₂—LiₚMO_{q} (p, q is a positive number, M is P, Si, Ge, B, Al, Ga, or In), Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), or the like. These may be used alone or in a combination of two or more therefrom.

In an embodiment, the solid electrolyte may include, e.g., an oxide-based amorphous solid electrolyte such as Li₂O—B₂O₃—P₂O₅, Li₂O—SiO₂, Li₂O—B₂O₃, Li₂O—B₂O₃—ZnO, or the like.

As illustrated in FIG. 2, electrode tabs (a cathode tab and an anode tab) may protrude from each of the cathode current collectors 105 and the anode current collectors 125 included in each electrode cell to extend to one side of the case 160. The electrode tabs may be fused together with the one side of the case 160 to be connected to an electrode lead (a cathode lead 107 and an anode lead 127) that are extended or exposed to an outside of the case 160.

Although FIG. 2 illustrates that the cathode lead 107 and the anode lead 127 protrude from an upper side of the case 160 in a plan view, positions of the electrode leads are not limited thereto. For example, the electrode leads may protrude from at least one of both sides of the case 160, or may protrude from a lower side of the case 160. Alternatively, the cathode lead 107 and the anode lead 127 may be formed to protrude from different sides of the case 160.

For example, the lithium secondary battery may be fabricated in a cylindrical type using a can, a prismatic type, a pouch type, or a coin type.

Hereinafter, embodiments of the present disclosure are described in more detail with reference to experimental examples. However, the following examples are only given for illustrating the present invention and those skilled in the related art will obviously understand that various alterations and modifications are possible within the scope and spirit of the present invention. Such alterations and modifications are duly included in the appended claims.

### Experimental Example

### (1) Preparation of Electrode (Anode)

### Example 1

A mixture of artificial graphite and natural graphite in a weight ratio of 3:7 was used as the anode active material. The anode active material, PTFE as the binder, and carbon black as the conductive material were mixed in a weight ratio of 98:1:1 using a ball mill mixer to form a dry powder. Specifically, the dry powder was prepared by stirring and mixing at a stirring rate of 9,000 rpm for 6 minutes.

The dry anode powder was input into a lab calender (roll diameter: 88 mm, roll temperature: 85° C., 20 rpm) to prepare an anode sheet. The anode sheet was placed on both sides of copper foil, and then laminated using a pressurized roll maintained at 100° C. to prepare an anode.

### Example 2

The same anode active material and conductive material as those in Example 1 were mixed and stirred for 3 minutes (a first mixing) using a ball mill mixer at a stirring rate of 9,000 rpm to prepare a preliminary dry powder.

PTFE was added as a binder to the preliminary dry powder, and the mixture was stirred and mixed for 3 minutes (a second mixing) at a stirring rate of 9,000 rpm to prepare a dry powder.

A weight ratio of the anode active material, the binder and conductive material was that same as that in Example 1.

Thereafter, an anode was prepared using the same method as that in Example 1.

### Example 3

A dry powder and an anode were prepared using the same method as that in Example 1, except that only artificial graphite was used as the anode active material.

### Comparative Example 1

A dry powder and an anode were prepared using the same method as that in Example 2, except that the first mixing time was adjusted to 5 minutes and the second mixing time was adjusted to 1 minute.

### Comparative Example 2

A dry powder and an anode were prepared using the same method as that in Example 1, except that only natural graphite was used as the anode active material.

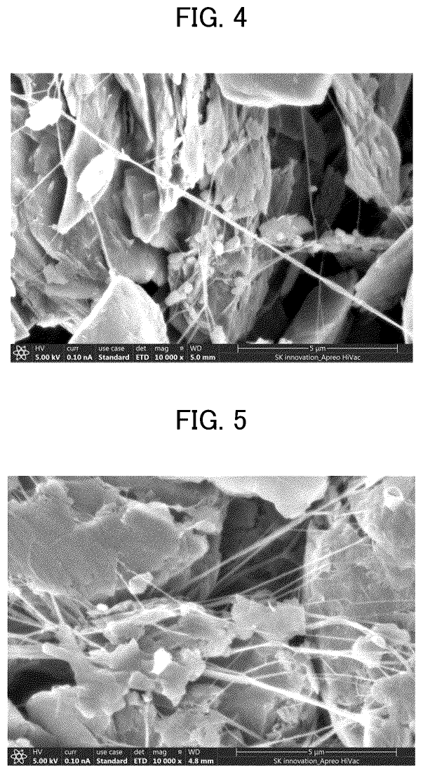

FIGS. 4 to 6 are scanning electron microscope (SEM) images of the anode powders of Examples 1, 2 and Comparative Example 1, respectively.

Referring to FIGS. 4 and 5, dry powders in which the binder fibrillation was sufficiently implemented were obtained in Examples.

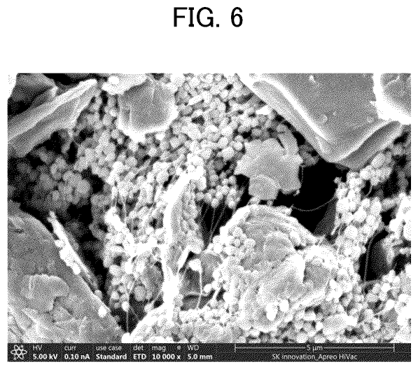

Referring to FIG. 6, the binder fibrillation did not substantially proceed, and crystallization or agglomeration were explicitly detected.

### (2) Measurement of Crystallinity Measurement of Dry Powder and Anode

A crystallinity as defined by Equation 1 of each of the dry powders and the anodes formed in Examples and Comparative Examples was measured using an XRD analysis from the surfaces of the anode active materials contained in the anodes.

The conditions of the XRD analysis are shown in Table 1 below.

TABLE 1
XRD(X-Ray Diffractometer)

| Maker | PANalytical | |
|---|---|---|
| Model | EMPYREAN | |
| Anode material | Cu | |
| K-Alpha1 wavelength | 1.540598 | Å |
| Generator voltage | 45 | kV |
| Tube current | 40 | mA |

| | |
|---|---|
| Scan Range | 10~70° |
| Scan Step Size | 0.0065° |
| Divergence slit | ¼° |
| Antiscatter slit | 1° |

### 1) Measurement of Crystallinity of Dry Powder

Five analyses were performed for each dry powder from Examples and Comparative Examples, and an average value was used as a crystallinity of each dry powder. The results of the dry powder crystallinity using Equation 1 are shown in Table 2 below.

TABLE 2

| | measurement | | | crystallinity | | standard | |
|---|---|---|---|---|---|---|---|
| | number | I_{PTFE}(100) | I_{GR}(002) | (Equation 1) | average | deviation | % RSD |
| Example 1 | 1 | 2076 | 294540 | 0.007048 | 0.006288 | 0.000744 | 11.8% |
| | 2 | 2082 | 295420 | 0.007048 | | | |
| | 3 | 1962 | 313472 | 0.006259 | | | |
| | 4 | 2052 | 406848 | 0.005044 | | | |
| | 5 | 2190 | 362613 | 0.006039 | | | |
| Example 2 | 1 | 2368 | 264055 | 0.008968 | 0.008807 | 0.000159 | 1.8% |
| | 2 | 2236 | 262527 | 0.008517 | | | |
| | 3 | 2240 | 254090 | 0.008816 | | | |
| | 4 | 2140 | 239454 | 0.008937 | | | |
| | 5 | 2178 | 247557 | 0.008798 | | | |
| Example 3 | 1 | 1993 | 232633 | 0.008567 | 0.008975 | 0.000352 | 3.9% |
| | 2 | 2013 | 232898 | 0.008643 | | | |
| | 3 | 2242 | 242104 | 0.00926 | | | |
| | 4 | 2012 | 225544 | 0.008921 | | | |
| | 5 | 2018 | 212780 | 0.009484 | | | |
| Comparative | 1 | 2134 | 225913 | 0.009446 | 0.009952 | 0.001229 | 12.3% |
| Example 1 | 2 | 1974 | 214050 | 0.009222 | | | |
| | 3 | 2446 | 198304 | 0.012335 | | | |
| | 4 | 2102 | 235770 | 0.008915 | | | |
| | 5 | 1975 | 200633 | 0.009844 | | | |
| Comparative | 1 | 1989 | 351508 | 0.005658 | 0.006631 | 0.000738 | 11.1% |
| Example 2 | 2 | 1869 | 306795 | 0.006092 | | | |
| | 3 | 1951 | 286007 | 0.006822 | | | |
| | 4 | 1876 | 277865 | 0.006751 | | | |
| | 5 | 1994 | 254637 | 0.007831 | | | |

### 2) Measurement of Anode Crystallinity

Five random points on a surface of the anode active material layer were selected from each of Examples and Comparative Examples, and the XRD analysis was performed on each point. An average of the measured values was used as an anode crystallinity. The crystallinity measurement results for the anode using Equation 1 are shown in Table 3 below.

TABLE 3

| | measurement | | | crystallinity | | standard | |
|---|---|---|---|---|---|---|---|
| | number | I_{PTFE}(100) | I_{GR}(002) | (Equation 1) | average | deviation | % RSD |
| Example 1 | 1 | 1710 | 525405 | 0.003255 | 0.003721 | 0.000447 | 12.0% |
| | 2 | 2175 | 502426 | 0.004329 | | | |
| | 3 | 2057 | 586604 | 0.003507 | | | |
| | 4 | 2096 | 501184 | 0.004182 | | | |
| | 5 | 1999 | 600268 | 0.00333 | | | |
| Example 2 | 1 | 2242 | 597462 | 0.003753 | 0.003545 | 0.000155 | 4.4% |
| | 2 | 2021 | 596470 | 0.003388 | | | |
| | 3 | 2198 | 601234 | 0.003656 | | | |
| | 4 | 2014 | 601458 | 0.003349 | | | |
| | 5 | 2143 | 598726 | 0.003579 | | | |
| Example 3 | 1 | 1507 | 452740 | 0.003329 | 0.003522 | 0.000158 | 4.5% |
| | 2 | 1648 | 443362 | 0.003717 | | | |
| | 3 | 1658 | 455385 | 0.003641 | | | |
| | 4 | 1522 | 455163 | 0.003344 | | | |
| | 5 | 1632 | 456160 | 0.003578 | | | |
| Comparative | 1 | 1978 | 381977 | 0.005178 | 0.005235 | 0.000851 | 16.3% |
| Example 1 | 2 | 1643 | 301973 | 0.005441 | | | |
| | 3 | 2468 | 451698 | 0.005464 | | | |
| | 4 | 1774 | 475183 | 0.003733 | | | |
| | 5 | 1989 | 312687 | 0.006361 | | | |
| Comparative | 1 | 1595 | 327004 | 0.004878 | 0.005123 | 0.000238 | 4.6% |
| Example 2 | 2 | 1724 | 322588 | 0.005344 | | | |
| | 3 | 1632 | 310479 | 0.005256 | | | |
| | 4 | 1517 | 316454 | 0.004794 | | | |
| | 5 | 1738 | 325332 | 0.005342 | | | |

### (3) Measurement of Anode Resistance

For each of the anodes in the Examples and Comparative Examples, a bulk resistance of an entire anode and an interfacial resistance between a current collector and the anode active material layer were measured using a device XF057 of Hioki at a measurement current of 10 mA and a measurement voltage of 0.5 V. Specifically, the electrode resistance (the bulk resistance) and the interfacial resistance were each measured twice, and an average value was calculated.

Based on the calculated average value, resistance properties were evaluated as follows.
◯: Electrode resistance less than 0.02 Ωcm, interfacial resistance less than 0.001 Ωcm²
Δ: Electrode resistance between 0.02 Ωcm and 0.05 Ωcm, interfacial resistance between 0.001 Ωcm² and 0.006 Ωcm²
x: Electrode resistance greater than 0.05 Ωcm, interfacial resistance greater than 0.006 Ωcm²

The evaluation results are shown in Table 4 below.

TABLE 4

| | electrode resistance (Ω cm) | | | | interfacial resistance (Ω cm²) | | | |
|---|---|---|---|---|---|---|---|---|
| | | | | resistance | | | | resistance |
| | 1 | 2 | average | property | 1 | 2 | average | property |
| Example 1 | 0.01365 | 0.02007 | 0.01686 | ◯ | 0.000686 | 0.01076 | 0.00572 | Δ |
| Example 2 | 0.01406 | 0.01475 | 0.01441 | ◯ | 0.000517 | 0.000902 | 0.00071 | ◯ |
| Example 3 | 0.01394 | 0.01786 | 0.01590 | ◯ | 0.000765 | 0.000916 | 0.00084 | ◯ |
| Comparative | 0.06984 | 0.0629 | 0.06637 | × | 0.0176 | 0.01565 | 0.01663 | × |
| Example 1 | | | | | | | | |
| Comparative | 0.02781 | 0.02755 | 0.02768 | Δ | 0.002272 | 0.002377 | 0.00232 | Δ |
| Example 2 | | | | | | | | |

Referring to Table 4, in Examples having the crystallinity values within the range of the above-described Equation 1, entirely reduced bulk resistance and interfacial resistance were measured compared to those from Comparative Examples.

What is claimed is:

1. An anode for a secondary battery, comprising:
an anode current collector; and
an anode active material layer formed on a surface of the anode current collector and comprising a graphite-based active material as an anode active material and polytetrafluoroethylene (PTFE) as a binder,
wherein a crystallinity defined by Equation 1 and measured on a surface of the anode active material layer is 0.005 or less:
$$crystallinity = {I}_{PTFE} ( 1 \; 00 ) / {I}_{GR} ( 002 ) \qquad [ Equation 1 ]$$
wherein, in Equation 1, I_{PTFE}(100) is an intensity of a peak corresponding to a (100) plane of PTFE in an X-ray diffraction (XRD) graph obtained by an XRD analysis, and I_{GR}(002) is an intensity of a peak corresponding to a (002) plane of graphite in the XRD graph.

2. The anode for a secondary battery of claim 1, wherein the crystallinity of the anode active material layer of Equation 1 is in a range from 0.002 to 0.005.

3. The anode for a secondary battery of claim 1, wherein the anode active material comprises artificial graphite.

4. The anode for a secondary battery of claim 3, wherein the anode active material further comprises natural graphite, and
a content of artificial graphite is greater than or equal to a content of natural graphite based on a total weight of the anode active material.

5. The anode for a secondary battery of claim 4, wherein the content of artificial graphite is 10 wt % to 90 wt % based on the total weight of the anode active material.

6. The anode for a secondary battery of claim 1, wherein the anode active material layer further comprises a conductive material, and
a content of the anode active material is in a range from 85 wt % to 99 wt %, a content of the binder is in a range from 0.1 wt % to 10 wt %, and a content of the conductive material is in a range from 0.1 wt % to 10 wt %, based on a total weight of the anode active material layer.

7. The anode for a secondary battery of claim 1, wherein the crystallinity of Equation 1 is an average of measured values at a plurality of points on the surface of the anode active material layer.

8. The anode for a secondary battery of claim 7, wherein a relative standard deviation (RSD) of the measured values is 10% or less.

9. The anode for a secondary battery of claim 7, wherein a relative standard deviation (RSD) of the measured values is 5% or less.

10. A secondary battery, comprising:
the anode for a secondary battery of claim 1; and
a cathode opposing the anode.

11. The secondary battery of claim 10, wherein the cathode comprises a cathode active material layer that includes a cathode active material and PTFE as a binder.

12. A method for fabricating an anode for a secondary battery, comprising:
mixing a graphite-based active material as an anode active material, polytetrafluoroethylene (PTFE) as a binder, and a conductive material to prepare a dry powder; and
calendering the dry powder to prepare an anode sheet,
wherein a crystallinity of the dry powder defined by Equation 1 is 0.009 or less;
$$crystallinity = {I}_{PTFE} ( 1 \; 00 ) / {I}_{GR} ( 002 ) \qquad [ Equation 1 ]$$
wherein, in Equation 1, I_{PTFE}(100) is an intensity of a peak corresponding to a (100) plane of PTFE in an X-ray diffraction (XRD) graph obtained by an XRD analysis, and I_{GR}(002) is an intensity of a peak corresponding to a (002) plane of graphite in the XRD graph.

13. The method of claim 12, wherein the crystallinity of the dry powder defined by Equation 1 is 0.005 or more, and less than 0.009.

14. The method of claim 12, wherein the preparing the dry powder comprises:
preparing a preliminary powder by stirring the anode active material and the conductive material by a first mixing process; and
stirring the preliminary powder and the binder by a second mixing.

15. The method of claim 14, wherein a stirring rate of the first mixing and the second mixing are each 6,000 rpm or more, and
a stirring time of the second mixing is greater than or equal to a stirring time of the first mixing.
